(19) United States
(12) Patent Application Publication
(10) Pub. No.: US 2008/0029139 A1
(43) Pub. Date: Feb. 7, 2008

(54) Attachable snap on crutch

(76) Inventor: Jerome Stanley Pijanowski, Redhouse, VA (US)

Correspondence Address: Jerome Stanley Pijanowski, 1181 Laurel Brook Lane, Red House, VA, 23963, US

(21) Appl. No.: 11/880,307

(22) Filed: Jul. 20, 2007

Related U.S. Application Data
(60) Provisional application No. 60/821,233, filed on Aug. 2, 2006.

(51) Int. Cl. A61H 3/00

(52) U.S. Cl. 135/67

(57) ABSTRACT

A vertically adjustable crutch that attaches, detaches and reverses to a handicap walker, quickly and without tools, providing combined support of both medical aids. This crutch involves no handgrip allowing user to maintain the comfort of same walker handgrip. A crutch being a three section assembly with first and third sections made slidable into second center body section, for top and bottom adjustments. A crutch having clips attached to center and lower sections for attaching to both top and lower rails of the walker. Each clip having a non-skid material on its underside preventing slippage or metal-to-metal contact. Each clip also having an h/l strap attached to secure accidental or unintentional release. The crutch may be designed with a 1″ offset to its center section vertical side rails to accommodate bottom clip to position at top center of bottom walker rail, insuring positive bearing weight.

### CROSS REFERENCE TO RELATED APPLICATIONS

This is a continuation in part of Ser. No. U.S. 60/821,233, filed on Aug. 2, 2006, and is also based on provisional application Ser. No. U.S. 60/821,233, filed on Aug. 2, 2006.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Medical Ambulatory aids and more specifically to an attachable snap on crutch that offers complete security to the handicaped person by allowing for more and easier access to travel by automobile,bus, train, airline and other modes than ever before. An invention made lightweight and with low number of parts thereby keeping costs of manufacture to a minimum.

We are all familiar with the handicap walker, one of the greatest ambulatory devises ever invented, but the walker has its shortcomings. A walker doesn't hold the user up by itself, they depend on their frail wrists, arms and legs to get around. Our generation is getting older every day and many older and handicaped people are falling every day and when they do they break bones and that can be like a death sentence to some of them. Then they are robbed of their dignity and ability to do for themselves. This invention the attachable snap on crutch gives those persons something that a walker doesn't, the combination of this crutch and the handicap walker will support their weight and bodies when they give out. It will allow them the confidence and trust to travel more places and distances without fear of falling or getting back to their rooms or homes than ever before. It even allows for the exercise that most never attempt these crutches can be installed or removed in seconds, without tools, having no left or right positioning they can also be reversed to the outside of the walker to accommodate a larger torso. Once adjusted to the individual they never need adjustments again. The attachable snap on crutch would be designed and made of light weight aluminum tubing with heavy gauge aluminum or stainless steel clips, to allow lightness in weight while closely matching most walkers in appearance and aesthetic quality while most walkers maintain a very close proximity between the top rails and the lower stabilizing rails on each side, the attachable snap on crutch has both a top adjustment and a bottom adjustment, allowing each set of clips to meet both rails in a secure position, thereby applying equal user weight to the handicap walker while accommodating both taller, shorter and wider individuals many patients after back and leg surgery may find it invaluable when moving about with the added balance and support it offers at such a crucial time. The purpose of a crutch is to aid the user by giving assistance in walking, by supporting their weight while allowing them access to move to or visit areas they might not have access to, due to an injury, disability or age altering condition. A person using crutches may not be provided with much stability or confidence and may be impaired due to the unstable effects that can occur while trying to maintain balance. Similar problems arise with a patient while on a handicap walker. While the walker allows the user to negotiate from one desired area to the next their support may deminish in some degree, leaving them too weak or unable to return or continue. Combinations of crutch and walkers have been introduced, however there are several shortcomings in both the production and operation aspects of these inventions that would be desireable to cure. These include:

U.S. Pat. Pub. No.: US 2004/0020525 A1 to Harry Lev, (Feb. 5, 2004) and: U.S. Pat. No. 5,411,044 to Alexander S. Andolfi, Issued (May 2, 1995) including U.S. Pat. Nos. 4,341,381; 3,195,550; 3,273,888; 2,732,004; 1,307,058; 130,283; 4,187,869; 2,362,466; and, 906,845.

The present background art of each of these and the combination of them together seem awkward, heavy, non-portable and restrictive to doorways and toiletry areas as well as needing various tools to adapt and adjust them.

The primary objective of the present invention the attachable snap on crutch is to provide a light weight quickly adjustable and removable aid and support that allows the user the independence and option of adding it or removing it at will, without tools or assistance from another party. As the handicap walker was designed to be lifted by the user in turning or raising for curbs etc., the light weight of this crutch does not interfere. The ability of the individual to travel by automobile, bus or airline with the attachable short crutches allows for easier accommodations

Other background art of individual crutch patents plainly show more costly and higher numbers of parts requiring assembling and adjusting needs and the visibly longer lengths that would hinder storage, shipping, low production costs and non-attachable qualities. These include:

U.S. Pat. No. 6,557,571 B1 to Jimmie Reuben Shultz (May 6, 2003) and: U.S. Pat. No. 6,655,400 B2 to Kyungil Cho (Dec. 2, 2003)

The longer lengths of crutches mentioned may sometimes cause unstable and/or difficulty to those who might lack strength, balance or inability to control movement without assistance, especially on smooth or inclined surfaces. And their longer length requires more room for storage and portability. Very serious falls can occur when patients lose balance and become frightened or attempt to sit or rise to use these unfamiliar medical aids.

Clearly a need exists for the combination of a crutch and walker that provides the full advantage of both devices while not introducing the disadvantages that the prior art employs. When traveling by automobile, bus, train or air the weight, length and total size can restrict access to these modes of travel due to these factors. When the user can quickly detach and fold the medical aid they use, all these modes of travel are immediately open to them. The object of this present invention is to overcome most of the disadvantages of the prior art of these combinations in existence. The disadvantages of most prior art covers the fact that various tools must be on hand to disassemble any parts when shipping, travel or access through some doors or different levels is required. This procedure usually requires help from another individual as well. Another advantage of the present invention is its very light weight, while closely matching most walkers in appearance and aesthetic quality.

### BRIEF SUMMARY OF THE INVENTION

The primary object of the invention is to aid the user by giving assistance in walking, by supporting their weight while allowing them access to move to or visit areas they might not otherwise have access to, due to an injury, disability or age altering condition.

Another object of the invention is to allow for height and width adjustments and for attachment to most any walker available.

Another object of the invention is to be quickly attached or removed without tools for transport or storage.

A further object of the invention is to provide a much more stable, safe and supportive mode of ambulatory movement.

Yet another object of the invention is to reduce costs in manufacture,storage, transporting and shipping due to the short length, light weight, and small number of parts.

Still yet another object of the invention is to allow the handicaped user the option of longer travel distance or exercise time.

Another object of the invention is to instill the confidence and trust this combination provides in their own weakened bodies.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an attachable crutch that adapts to a handicap walker comprising: The present invention relates to walking aids and can be quickly attached without tools to the handicap walker both folding and fixed of many and different manufacturers, to produce a much more stable, safer and supportive mode of ambulatory movement. The uniqueness of this invention is the built in height adjustment allowing for both tall or shorter persons as well as its ability to accommodate wider individuals with outside crutch positioning. Another unique quality is the absence of the handgrip the usual crutch employs, allowing the user the comfort of using their own walker handgrip, as well as saving production costs per crutch.

In accordance with a preferred embodiment of the invention, there is disclosed a attachable Snap on Crutch comprising: This invention attaches to the top rail and the bottom rail of a handicap walker quickly and simultaneously, by way of metal clips positioned on its center body section and the lower third section of the crutch, This crutch being a three section assembly with first and third sections made slidable into second center section, for top and bottom adjustments. The clips having non-skid material on their undersides and a Velcro—type H/L strap attached to prevent accidental or unintentional release, A vertically adjustable crutch that attaches, detatches and reverses to a handicap walker quickly and without tools and once adjusted never needs adjusting again. The short length, light weight and low number of parts may make storing, transporting, manufacture and shipping easier and cheaper. Another unique feature is that this invention can give the user the confidence to trust their ability to exercise without fear of losing balance or strength of limbs to continue. This invention may be modified to a custom length to each manufacturers own particular walker model, thereby lowering manufacturing costs.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. (1) is a plan view of the invention attached to a typical handicap walker

FIG. (2) is an side elevation view of the invention

FIG. (2a) is a isometric elevation view of invention

FIG. (3) is a top section view of the invention

FIG. (3a) is a center section view of the invention

FIG. (3b) is a bottom section view of the invention

FIG. (4) is a sectional view of the top clip design and placement

FIG. (5) is a sectional view of the bottom clip design and placement

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

This invention allows the handicap person to use the walker they presently own without having to purchase another type, as it is constructed to adapt to most walkers now in production, both adjustable and fixed types. Sometimes these persons must be on their walker for longer periods than their frail bodies can handle, but with the attachable snap on crutch as extra support they may be comfortable to be willing to risk longer trips and have the ability to visit many other places. With minimal number of parts and hardware to assemble in its design the cost of the crutch should not be out of reach.

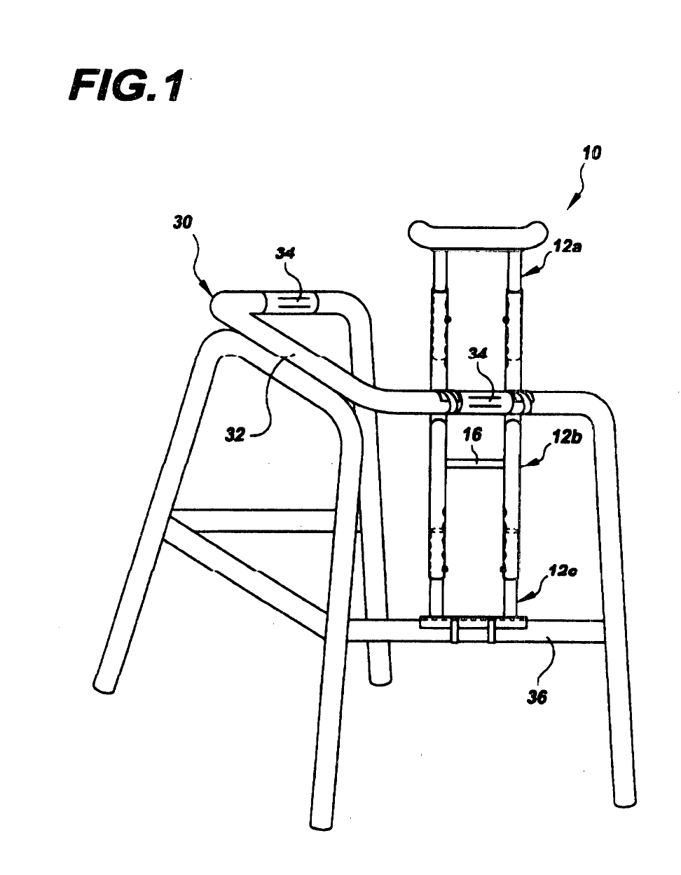

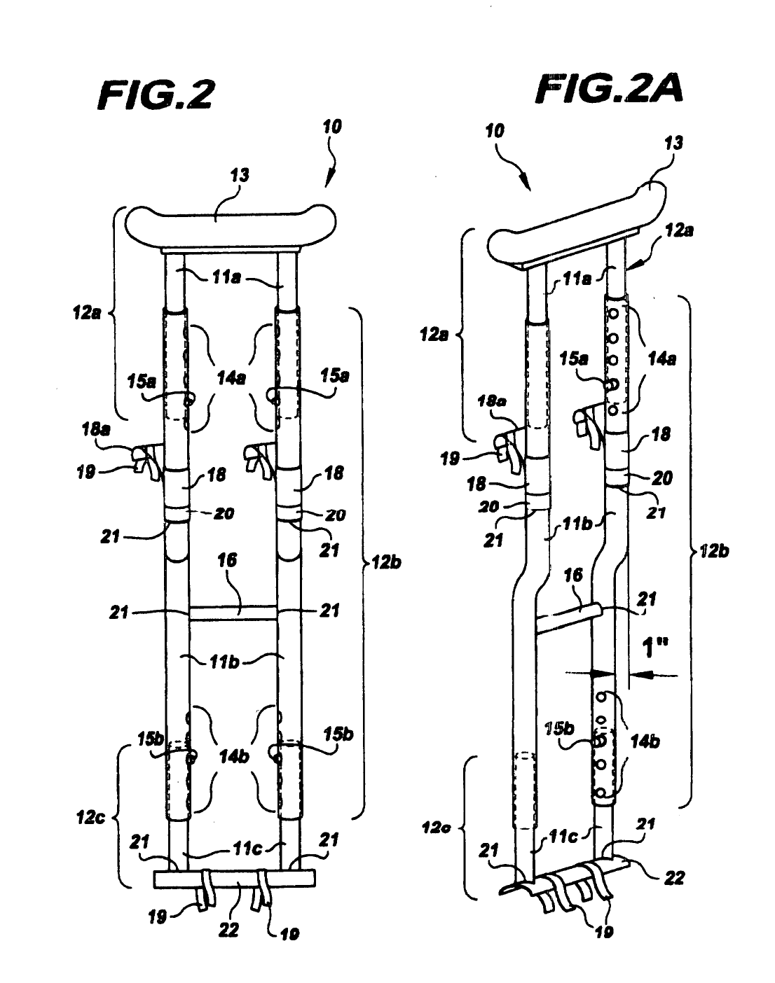

In accordance with the present invention, FIG. 1 shows a plan view of the crutch attached to a typical handicap walker. Turning next to FIGS. 2, a view of the side elevation and FIG. 2A, an isometric view of the present invention shows a three sectional snap on crutch of low number of parts and simplistic design.

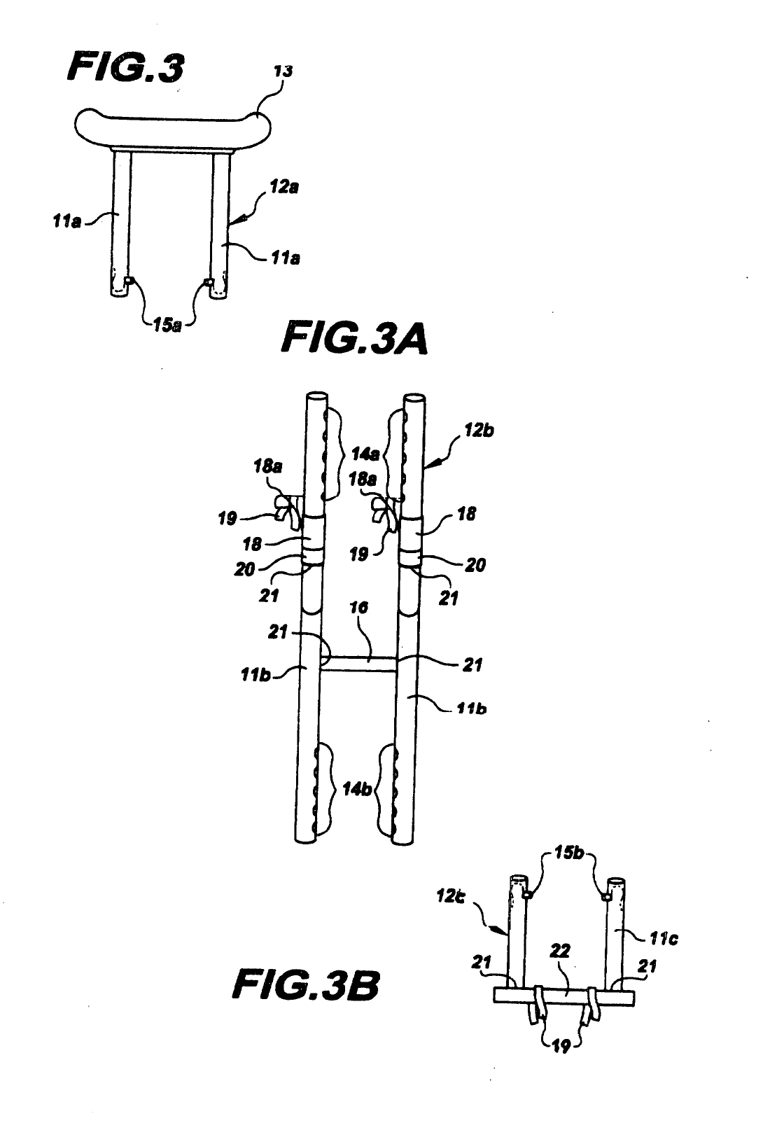

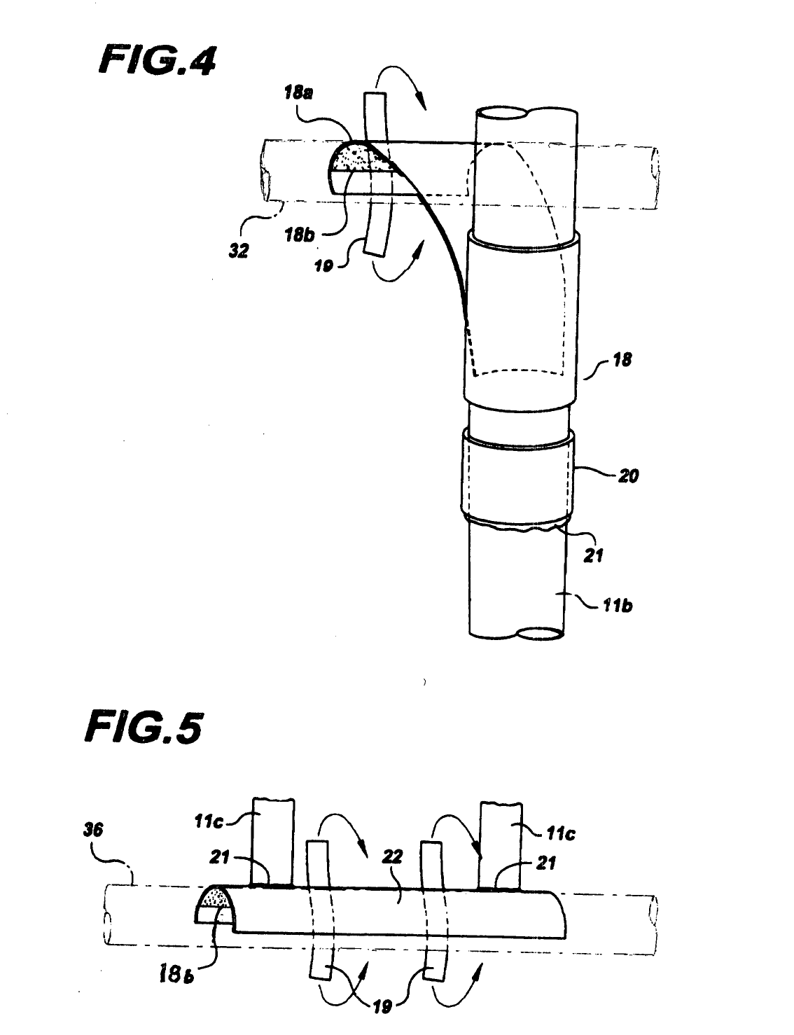

This invention attaches to the top rail (32) and the bottom rail (36) of a walker (30) simultaneously, by way of metal clips (18) & attachment (18a) positioned on the center section (12b) and clip (22) on lower section (12c) of the crutch. Turning to FIGS. 3, FIG. 3A, and FIG. 3B, The views of Top, Center and Lower sections of crutch unit are shown in viewable positions of assembly. Both height adjustments and crutch to walker adjustments are achieved by utilization of push button release pins (15) & (15a) in both top section (12a) and bottom section (12c) of the crutch, when either is slid into center section (12b) of crutch unit (10) stopping at desired hole locations (14a) & (14b). A brace (16) connects the center section side rails (11b) together to maintain stability. A non-stick material (18b) may be applied to the underside of bottom clip (22) and top clip attachment (18a) to prevent shifting as well as for cushioning between metal-to-metal contact. FIGS. 4, and FIG. 5, present sectional views of Top clips (18) and Bottom clips (22) respectively as incorporated in crutch design. The Top clips (18) may be welded in desired position or made slidable over center section (12b) side rail (11b) and kept in place by a welded (21) stop collars (20). An h/l (Velcro-type) strap (19) attached to each top clip attachment (18a) and bottom clip (22) secures the crutch in place and prevents the crutch from shifting and accidental uncoupling.

If only a single crutch is desired only one crutch need be attached. Reversing the crutch from inside the walker rails to the outside of the walker rails allows it to be installed when hinges or other objects may interfere with inside mounting, and also allows users with a wider torso more width and comfort. Many patients after back and/or leg surgery and/or serious medical operations may find this combination invaluable when moving about with the added balance and support that may be offered at such a critical time. Should they lose strength in legs,arms or wrists etc.,this crutch would be their main support, allowing them to maintain their weight and balance. The short length, light weight and easily detachable factor makes its storage and portability unique as a crutch

### NUMERICAL PARTS DESCRIPTION OF INVENTION

(10) Snap-on Crutch (13) crutch cap

(30) walker (16) crutch brace

(32) walker top rail (22) bottom clip

(36) walker bottom rail (18) top clip

(34) walker handgrip (18a) attachment to top clip

(12a) top section (18b) non-slip material

(12b) center section (19) h/l strap

(12c) lower section (20) stop collar

(15a) & (15b) push button release pins (21) weld

(14a) & ( 14b) button holes

(11a) top section side rails

(11b) center section side rails

(11c) lower section side rails

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An attachable crutch that adapts to a handicap walker comprising:
(a) the present invention relates to a walking aids that can be quickly attached and removed without tools to the handicap walker both folding and fixed, of many and different manufacturers, to produce a much more stable, safer and less expensive supportive mode of ambulatory movement.
(b) the uniqueness of this invention is the built in height adjustment allowing for both tall or shorter persons as well as its ability to accomadate wider individuals with outside crutch positioning.
(c) another unique quality is the absence of the handgrip the usual crutch employs, allowing the user the comfort of using their own walker handgrip, as well as saving production costs per crutch.
(d) another unique feature of this invention is that once the crutch is attached to the walker it cannot be accidentally or unintentionally removed without destroying the crutch or the walker itself, but when desired can be removed and /or reattached in seconds without tools.
(e) another unique quality of this invention is that it can give the user confidence to trust their ability to exercise without fear of losing balance or strength of limbs.
(f) another unique feature of this invention is the suggested 1″ offset in the middle center body section of the crutch insures that the users weight is distributed equally to the handicap walker, allowing positive support and maximum strength and safety for the invalid user.
(g) another unique feature is its quick and easy removable features when travel accomadations require, as is; taxi, bus, airline or when weather conditions dictate.

2. Attachable Snap on Crutch comprising:
(k) this invention attaches to the top rail and the bottom rail of a handicap walker quickly and simultaneously, by way of metal clips positioned on its center body section and the lower third section of the crutch;
(l) this crutch being a three section assembly with first and third sections made slidable into second center body section, for top and bottom adjustments;
(m) the clips having non-skid material in their undersides and a Velcro type H/L strap attached to prevent accidental or unintentional release;
(n) a vertically adjustable crutch that attaches, detatches and reverses to a handicap walker quickly and without tools and once adjusted never needs adjusting again.
(o) the short length, light weight and low number of parts may make storing, transporting, manufacture and shipping cheaper;
(p) another unique feature is that this invention can give the user the confidence to trust their ability to exercise without fear of losing balance or strength of limbs to continue.
(q) this invention may be modified to a custom length to each manufacturers own particular walker model, thereby lowering manufactur costs.
